(19) United States
(12) Patent Application Publication
(10) Pub. No.: US 2022/0067659 A1
(43) Pub. Date: Mar. 3, 2022

(54) RESEARCH AND DEVELOPMENT SYSTEM AND METHOD

(71) Applicants: UNIORANGE INTERNET DESIGN CO., LTD., Yantai (CN); BEIJING UNIORANGE TECHNOLOGY CO., LTD., Beijing (CN)

(72) Inventors: Yingfang ZHAO, Yantai (CN); Xiujuan ZHAO, Yantai (CN); Hongjie SHEN, Beijing (CN); Jinlin XIE, Beijing (CN)

(73) Assignees: UNIORANGE INTERNET DESIGN CO., LTD., Yantai (CN); BEIJING UNIORANGE TECHNOLOGY CO., LTD., Beijing (CN)

(21) Appl. No.: 17/245,926

(22) Filed: Apr. 30, 2021

(30) Foreign Application Priority Data
Aug. 25, 2020 (CN) 202010864013.9

(51) Int. Cl. G06Q 10/10; G06Q 10/06; G06Q 10/08; G06N 3/02

(52) U.S. Cl. CPC G06Q 10/101; G06Q 10/06316; G06N 3/02; G06Q 10/0875; G06Q 10/06312

(57) ABSTRACT

A research and development system and method are provided. The research and development system includes a cloud service sub-system and a cloud research and development sub-system in communicative connection with each other. The cloud service sub-system is configured to manage project information related to a target project. The cloud research and development sub-system is deployed with a cloud development environment and cloud development software, and is configured to acquire target project information in the project information from the cloud service sub-system, provide usage permission of the cloud development environment and corresponding cloud development software, and transmit, to the cloud service sub-system, a project file generated according to the target project information, so as to perform research and development on the target project.

### CROSS-REFERENCE TO RELATED APPLICATIONS

The present application claims priority of Chinese Patent Application No. 202010864013.9, filed on Aug. 25, 2020, the disclosure of which is incorporated herein by reference in its entirety as part of the present disclosure.

### TECHNICAL FIELD

Embodiments of the present disclosure relate to a research and development system and method.

### BACKGROUND

With popularization and application of “Internet+”, more and more industrial Internet platforms have emerged. The industrial Internet closely connects and integrates devices, production lines, factories, suppliers, products, and customers together through an open and globalized industrial-level network platform, and efficiently shares various element resources in the industrial economy, which thus, in an automated and intelligent production mode, reduces costs and increases efficiency, helps the manufacturing industry extend industrial chains, and promotes transformation and development of the manufacturing industry. For example, some enterprises adopt new architectures such as Platform as a Service (PaaS) and micro-services to build platforms, so as to provide better ability support for product research and development.

### SUMMARY

At least one embodiment of the present disclosure provides a research and development system, which comprises a cloud service sub-system and a cloud research and development sub-system in communicative connection with each other. The cloud service sub-system is configured to manage project information related to a target project. The cloud research and development sub-system is deployed with a cloud development environment and cloud development software, and is configured to acquire target project information in the project information from the cloud service sub-system, provide usage permission of the cloud development environment and corresponding cloud development software, and transmit, to the cloud service sub-system, a project file generated according to the target project information, so as to perform research and development on the target project.

For example, the research and development system provided by an embodiment of the present disclosure further comprises: a cloud communicating sub-system, deployed with a communication tool, and configured to provide usage permission of the communication tool, so that a plurality of target objects associated with the target project are capable of communicating through the communication tool.

For example, in the research and development system provided by an embodiment of the present disclosure, the cloud communicating sub-system is further configured to interact with the cloud service sub-system and the cloud research and development sub-system, so as to acquire shared information in the project information from the cloud service sub-system, and/or acquire research and development information from the cloud research and development sub-system.

For example, in the research and development system provided by an embodiment of the present disclosure, the cloud service sub-system comprises a demand releasing unit, a demand clarifying unit, and a project undertaking unit, and the target project information comprises a project demand; the demand releasing unit is configured to acquire a project demand proposed by a demander with respect to the target project, and release the project demand; the demand clarifying unit is configured to analyze the project demand to generate a demand definition document, and release the demand definition document, so that a project undertaker is capable of determining whether to undertake the target project according to the demand definition document; and the project undertaking unit is configured to grant, in response to receiving first confirmation information that the project undertaker confirms to undertake the target project, product development permission of the target project to the project undertaker in the research and development system.

For example, in the research and development system provided by an embodiment of the present disclosure, the cloud service sub-system further comprises: a technology splitting tool, configured to split the project demand into a plurality of sub-project demands. The demand clarifying unit is further configured to analyze each sub-project demand in the plurality of sub-project demands to generate a plurality of sub-demand definition documents, and release the plurality of sub-demand definition documents, so that a sub-undertaker is capable of determining, according to the plurality of sub-demand definition documents, whether to undertake a sub-project corresponding to the sub-project demand.

For example, in the research and development system provided by an embodiment of the present disclosure, the cloud service sub-system further comprises a sub-project undertaking unit, and the sub-project undertaking unit is configured to grant, in response to receiving second confirmation information that the sub-undertaker confirms to undertake the sub-project, product development permission of the sub-project to the sub-undertaker.

For example, in the research and development system provided by an embodiment of the present disclosure, the cloud service sub-system is further configured to determine, according to a project demand of the target project and by using a neural network technology, at least one project undertaker matching the project demand from a project undertaker library, and push the target project to the at least one project undertaker.

For example, in the research and development system provided by an embodiment of the present disclosure, managing the project information related to the target project comprises: releasing a project demand of the target project, splitting the project demand into a plurality of sub-project demands, managing undertaking information of the target project, and managing process of the target project.

For example, in the research and development system provided by an embodiment of the present disclosure, the cloud service sub-system further comprises a contract management module, an advisory service module, and a transaction management module. The contract management module is configured to generate a contract for the target project and manage the contract, the advisory service module is configured to receive consultation information from a demander, determine reply information of the consultation information, and feed the reply information back to the demander, and the transaction management module is configured to manage transaction information of the target project.

For example, in the research and development system provided by an embodiment of the present disclosure, the research and development system is capable of constructing a user credit system and a transaction security system by using a blockchain technology.

For example, in the research and development system provided by an embodiment of the present disclosure, the cloud research and development sub-system comprises a model library, the cloud research and development sub-system is further configured to receive a selection operation executed in the cloud development environment and the cloud development software, and determine, according to the selection operation, a selection model from the model library, and the selection model is used for research and development of the target project.

For example, in the research and development system provided by an embodiment of the present disclosure, the cloud research and development sub-system is further configured to generate a bill of materials of basic products used in research and development of the target project.

For example, in the research and development system provided by an embodiment of the present disclosure, the cloud research and development sub-system comprises a lightweight module, and the lightweight module is configured to perform lightweight processing on a model comprising a plurality of details during a research and development process, so as to demonstrate to a remote authorized user through a network.

For example, in the research and development system provided by an embodiment of the present disclosure, the cloud research and development sub-system comprises an intellectual property protecting module, and the intellectual property protecting module is configured to record technical information generated during a research and development process of the target project, and output a query result in response to receiving a query instruction for querying the technical information.

For example, in the research and development system provided by an embodiment of the present disclosure, the research and development system is a single sign-on system.

At least one embodiment of the present disclosure further provides a research and development method, applied to a research and development system. The research and development system comprises a cloud service sub-system and a cloud research and development sub-system, the cloud research and development sub-system is deployed with a cloud development environment and cloud development software, and the method comprises: acquiring and managing, through the cloud service sub-system, project information related to a target project, in which the project information comprises target project information; in response to acquiring a use request for using the cloud development environment and the cloud development software, providing usage permission of the cloud development environment and the cloud development software, so as to acquire the target project information in the project information from the cloud service sub-system and carry out research and development on the target project; and sending a project file generated according to the target project information to the cloud service sub-system by the cloud research and development sub-system.

For example, in the method provided by an embodiment of the present disclosure, the target project information comprises a project demand, and acquiring the project information related to the target project through the cloud service sub-system comprises: acquiring, through the cloud service sub-system, the project demand proposed by a demander with respect to the target project; analyzing the project demand to generate a demand definition document, and releasing the demand definition document, so that a project undertaker is capable of determining whether to undertake the target project according to the demand definition document; and granting, in response to receiving first confirmation information that the project undertaker confirms to undertake the target project, product development permission of the target project to the project undertaker in the research and development system.

For example, the method provided by an embodiment of the present disclosure further comprises: in response to receiving a splitting request, splitting the project demand into a plurality of sub-project demands according to the demand definition document; analyzing each sub-project demand in the plurality of sub-project demands to generate a plurality of sub-demand definition documents, and releasing the plurality of sub-demand definition documents, so that a sub-undertaker is capable of determining, according to the sub-demand definition documents, whether to undertake a sub-project corresponding to the sub-project demand; and in response to receiving second confirmation information that the sub-undertaker confirms to undertake the target project, updating the product development permission of the sub-project from the undertaker to the sub-undertaker.

For example, in the method provided by an embodiment of the present disclosure, the research and development system further comprises a cloud communicating sub-system, the cloud communicating sub-system is deployed with a communication tool, target objects associated with the target project comprise a first target object and a second target object, and the method further comprises: receiving a project message sent by the first target object through the communication tool, in which a target receiving object of the project message is the second target object; and sending the project message to the second target object through the communication tool.

For example, in the method provided by an embodiment of the present disclosure, the project message comprises at least one of a group consisting of audio and video messages, video conferences, document sharing messages, or desktop sharing messages.

### BRIEF DESCRIPTION OF THE DRAWINGS

In order to clearly illustrate the technical solution of the embodiments of the present disclosure, the drawings of the embodiments will be briefly described in the following. It is obvious that the described drawings in the following are only related to some embodiments of the present disclosure and thus are not limitative of the present disclosure.

FIG. 1 illustrates a schematic block diagram of a research and development system provided by at least one embodiment of the present disclosure;

FIG. 2 illustrates a schematic diagram of a cloud service sub-system 110 in FIG. 1 provided by at least one embodiment of the present disclosure;

FIG. 3 illustrates a schematic block diagram of a cloud research and development sub-system 120 provided by at least one embodiment of the present disclosure;

FIG. 4 illustrates a schematic diagram of another research and development system 400 provided by at least one embodiment of the present disclosure;

FIG. 5 illustrates a flow chart of a research and development method provided by at least one embodiment of the present disclosure;

FIG. 6 illustrates a flow chart of step S20 in FIG. 5 provided by at least one embodiment of the present disclosure;

FIG. 7 illustrates a flow chart of another research and development method provided by at least one embodiment of the present disclosure;

FIG. 8 illustrates a flow chart of another research and development method provided by at least one embodiment of the present disclosure;

FIG. 9 illustrates a structural schematic diagram of another research and development system provided by at least one embodiment of the present disclosure;

FIG. 10A illustrates a schematic block diagram of a server provided by some embodiments of the present disclosure; and

FIG. 10B illustrates a schematic block diagram of an electronic device provided by some embodiments of the present disclosure.

### DETAILED DESCRIPTION

The exemplary embodiments will be described in detail here, and examples thereof are illustrated in the accompanying drawings. When the following description refers to the drawings, unless otherwise indicated, the same numbers in different drawings indicate the same or similar elements. The implementation manners described in the following exemplary embodiments do not represent all implementation manners consistent with the present disclosure. On the contrary, they are merely examples of devices consistent with some aspects of the present disclosure as detailed in the appended claims.

The terms used in the present disclosure are only for the purpose of describing specific embodiments, and are not intended to limit the present disclosure. Unless otherwise determined, the technical terms or scientific terms used in the present disclosure shall have the usual meanings understood by those with ordinary skills in the field to which the present disclosure belongs. The “first”, “second” and similar words used in the claims and descriptions of the present disclosure do not denote any order, quantity or importance, but are only used to distinguish different components. Similarly, similar words such as “one” or “a” do not mean a quantity limit, but mean that there is at least one. “Multiple” or “several” means two or more. “Including” or “comprising” and other similar words mean that the elements or items before “including” or “comprising” cover the elements or items listed after “including” or “comprising” and their equivalents, and do not exclude other elements or objects. Similar words such as “connected” or “connecting” are not limited to physical or mechanical connections, and may include electrical connections, whether direct or indirect. The singular forms of “a”, “said” and “the” used in the description and the appended claims of the present disclosure are also intended to include plural forms, unless the context clearly indicates other meanings. It should also be understood that the term “and/or” as used herein refers to and includes any or all possible combinations of one or more associated listed items.

In recent years, the industrial Internet platform has developed vigorously, and emergence of the industrial Internet has improved efficiency and reduced costs of product research and development. In a related art, although use of the industrial Internet platform for product research and development has improved efficiency of product research and development to a certain extent, yet efficiency of product research and development is still low and needs to be further improved. Therefore, at least one embodiment of the present disclosure provides a research and development system. The research and development system can improve efficiency of product research and development, implement full-element online collaborative research and development, and facilitate joint research and development of a plurality of participants.

The research and development system provided by at least one embodiment of the present disclosure includes a cloud service sub-system and a cloud research and development sub-system in communicative connection with each other. The cloud service sub-system is configured to manage project information related to a target project. The cloud research and development sub-system is deployed with a cloud development environment and cloud development software, and is configured to acquire target project information from the cloud service sub-system, provide usage permission of the cloud development environment and corresponding cloud development software, and transmit, to the cloud service sub-system, a project file generated according to the target project information, so as to perform research and development on the target project.

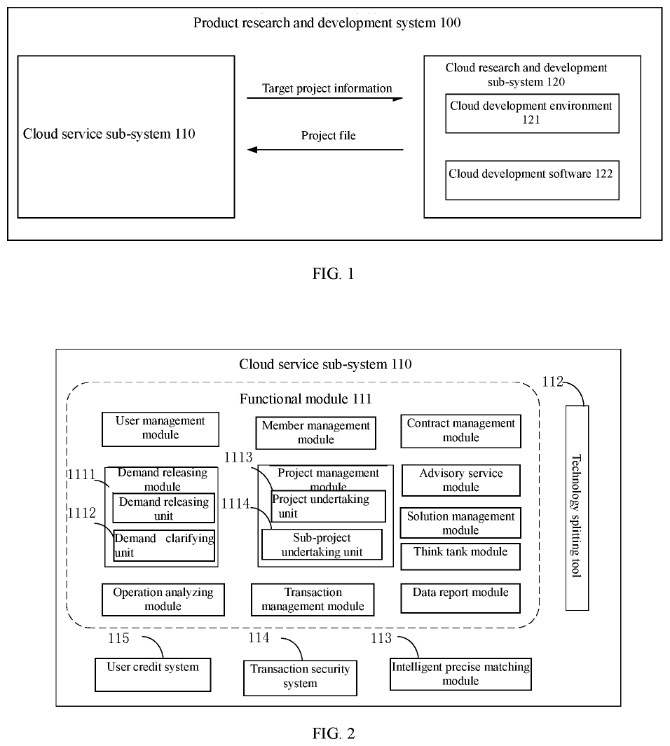

FIG. 1 illustrates a schematic block diagram of a research and development system provided by at least one embodiment of the present disclosure.

As illustrated in FIG. 1, a research and development system 100 may include a cloud service sub-system 110 and a cloud research and development sub-system 120. The cloud service sub-system 110 and the cloud research and development sub-system 120 are in communicative connection with each other. The cloud research and development sub-system 120 is deployed with a cloud development environment 121 and cloud development software 122.

The cloud service sub-system 110 is configured to manage project information related to a target project.

The cloud research and development sub-system 120 is configured to acquire target project information in the project information from the cloud service sub-system 110, provide usage permission of the cloud development environment and corresponding cloud development software, and transmit, to the cloud service sub-system 110, a project file generated according to the target project information, so as to perform research and development on the target project.

In this embodiment, the research and development system 100 provides the cloud development environment and the cloud development software. In the research and development process of the target project, the cloud research and development sub-system may directly acquire the target project information from the cloud service sub-system and use the cloud development environment 121 and the cloud development software 122 provided to develop without additionally searching, installing and downloading any cloud development environment and cloud development software, thereby improving research and development efficiency and implementing full-element open online collaborative research and development, and facilitating joint research and development of a plurality of participants. Full elements may refer to, for example, various elements required for project research and development. Full elements may include, for example, various types of project information required for project research and development, various types of research and development software and environments, technical documents, and so on. The research and development system 100 may allow product research and development to be unrestricted by its own resources, and can make full use of advantages of the Internet, optimize resource allocation, and reduce offline work processes.

In some embodiments of the present disclosure, for example, the cloud development software 122 is an application installed in the cloud research and development sub-system, and the cloud development environment 121 is an application or a collection of a plurality of applications deployed in the cloud research and development sub-system.

In some embodiments of the present disclosure, the cloud service sub-system 110 and the cloud research and development sub-system 120 may be hardware, software, firmware, and any feasible combination thereof. For example, the cloud service sub-system 110 and the cloud research and development sub-system 120 may be dedicated or general-purpose circuits, chips, or apparatuses, etc., or may also be a combination of a processor and a memory. For example, the cloud service sub-system 110 and the cloud research and development sub-system 120 may be independent servers, respectively, which communicate with each other through a network; or, the cloud service sub-system 110 and the cloud research and development sub-system 120 may also be a same server, and the server runs different programs to implement a corresponding sub-system. Specific implementation forms of the above-described respective sub-systems are not limited in the embodiments of the present disclosure. The cloud service sub-system 110 and the cloud research and development sub-system 120 may communicate in a wireless or wired manner, or through a media such as optical fiber.

FIG. 2 illustrates a schematic diagram of the cloud service sub-system 110 in FIG. 1 provided by at least one embodiment of the present disclosure. The cloud service sub-system 110 is further described below in conjunction with FIG. 2.

As illustrated in FIG. 2, the cloud service sub-system 110 includes a functional module 111. The functional module 111 is configured to manage the project information related to the target project. The functional module 111 may include, for example, a user management module, a member management module, a contract management module, a demand releasing module, a project management module, an advisory service module, a solution management module, a transaction management module, a think tank module, an operation analyzing module, a data report module, and the like. The functional module 111 may implement efficient management and transformation of the target project's life cycle, and implement efficient integration of resources.

For example, the contract management module is configured to generate a contract for the target project, and manage the contract.

For another example, the advisory service module is configured to receive consultation information from a demander, determine reply information of the consultation information, and feed the reply information back to the demander.

The transaction management module is configured to manage transaction information of the target project. The transaction information may include, for example, payment information, settlement information, and other transaction-related information.

In some embodiments of the present disclosure, the above-described respective functional modules in the cloud service sub-system 110 may be hardware, software, firmware, and any feasible combination thereof. For example, the user management module, the member management module, the contract management module, the demand releasing module, the project management module, the advisory service module, the solution management module, the transaction management module, the think tank module, the operation analyzing module, the data report module, etc. may be dedicated or general-purpose circuits, chips, or apparatuses, etc., or may also be a combination of a processor and a memory. Specific implementation forms of the above-described respective functional modules are not limited in the embodiments of the present disclosure.

In some embodiments of the present disclosure, for example, the target project may be a project waiting for research and development, or a project under research and development, or a project having research and development completed.

For example, a user may log in to the cloud service sub-system 110 and manage the project information related to the target project.

For example, the project information related to the target project may include a project demand of the target project, as well as contract information, transaction information, business information, data reports, user information, etc. of the target project.

In some embodiments of the present disclosure, managing the project information related to the target project includes: releasing the project demand of the target project, splitting the project demand into a plurality of sub-project demands, managing undertaking information of the target project, and managing process of the target project.

In some embodiments of the present disclosure, the cloud service sub-system 110 may include a demand releasing unit, a demand clarifying unit, and a project undertaking unit. For example, as illustrated in FIG. 2, the demand releasing module may include a demand releasing unit 1111 and a demand clarifying unit 1112. The project management module may include a project undertaking unit 1113.

In some embodiments of the present disclosure, the demand releasing unit, the demand clarifying unit, and the project undertaking unit may be hardware, software, firmware, and any feasible combination thereof. For example, the demand releasing unit, the demand clarifying unit, and the project undertaking unit may be dedicated or general-purpose circuits, chips, or apparatuses, etc., or may also be a combination of a processor and a memory. Specific implementation forms of the above-described respective units are not limited in the embodiments of the present disclosure.

In some embodiments of the present disclosure, the target project information includes the project demand. The demand releasing unit 1111 is configured to acquire the project demand proposed by the demander with respect to the target project, and release the project demand. The demand clarifying unit 1112 is configured to analyze the project demand to generate a demand definition document, and release the demand definition document, so that a project undertaker is capable of determining whether to undertake the target project according to the demand definition document. The project undertaking unit 1113 is configured to grant, in response to receiving first confirmation information that the project undertaker confirms to undertake the target project, product development permission of the target project to the project undertaker in the research and development system.

For example, an enterprise or an individual having product upgrade or product research and development demands (hereinafter referred to as a “demander”) may log in to its own cloud service sub-system 110, and may select a “Release Demands” option in a front-end interface provided by the cloud service sub-system 110, so as to call the demand releasing unit 1111, and enter a demand releasing interface, and the user may execute an operation of releasing the project demand of the target project on the demand releasing interface, so as to release the project demand of the target project.

After the demander releases the demand, for example, the demand clarifying unit 1112 may analyze the project demand. The demand clarifying unit 1112 may, for example, call an advisory service module. The advisory service module may include an intelligent robot, and the intelligent robot provides advisory services. Alternatively, the advisory service module may notify a project advisor having technical expertise to provide advisory services. For example, the project advisor may call think tank resources in a think tank module in the functional module 111 through the demand clarifying unit 1112, so that the think tank resources may be used to clarify the project demand to generate the demand definition document, and thus release the demand definition document.

The project undertaker may judge whether it has the ability to undertake the target project according to the released demand definition document. Alternatively, the project undertaker may also communicate the target project with the project advisor according to the demand definition document, so as to more accurately judge whether the project undertaker has the ability of undertaking the target project. In this embodiment, a professional project advisor is introduced to provide third-party technical advisory services, the project demand of the demander is clarified, and the project demand is transformed into a professional demand definition document, which solves the technical problems of the demander and the project undertaker in project communication and implementation procedures, and greatly improves project implementation process. The project advisor is not limited to its own ability, and may also combine third-party think tank resources to jointly transform the demand of the demander.

In a related art, the industrial Internet platform usually only has back-end data maintenance personnel, the demander releases demand information, and the project undertaker checks the demand information, but there is no relevant professional technicians to clarify the demand information, thereby resulting in mismatched information between the two parties and low research and development efficiency. At least one embodiment of the present disclosure provides the demand clarifying unit, and the demand clarifying unit may clarify the project demand through professional technicians or robots, thereby improving research and development efficiency.

In some embodiments of the present disclosure, in the case where the project undertaker confirms that it has the ability to undertake the target project, then the project undertaker may execute a first confirmation operation in the cloud service sub-system 110, so that the cloud service sub-system 110 may generates the first confirmation information according to the first confirmation operation. In response to receiving the first confirmation information, the project undertaking unit grants product development permission of the target project to the project undertaker.

As illustrated in FIG. 2, the cloud service sub-system 110 may further include a technology splitting tool 112. The technology splitting tool 112 is configured to split the project demand into a plurality of sub-project demands. In this embodiment, the demand clarifying unit 1113 is further configured to analyze each sub-project demand in the plurality of sub-project demands to generate a plurality of sub-demand definition documents, and release the plurality of sub-demand definition documents, so that a sub-undertaker is capable of determining, according to the plurality of sub-demand definition documents, whether to undertake a sub-project corresponding to the sub-project demand. The project demand is split into a plurality of sub-project demands, so that the target project is refined into more specific sub-projects, and the project undertaker may more clearly define the technical problems to be solved.

For example, the demander or the project advisor or the project undertaker may use the technology splitting tool 112 to split the project, and release the split sub-projects on the research and development system, so as to facilitate the sub-project undertaker to undertake the sub-projects in the target project. For example, the demander or the project advisor or the project undertaker may split the project demand into the plurality of sub-project demands according to guidelines of a technology splitting toolkit.

In the embodiments of the present disclosure, the cloud service sub-system 110 further includes a sub-project undertaking unit, and the sub-project undertaking unit is configured to, in response to receiving second confirmation information that the sub-undertaker confirms to undertake the sub-project, grant product development permission of the sub-project to the sub-undertaker. As illustrated in FIG. 2, for example, the project management module may include a sub-project undertaking unit 1114 in addition to the project undertaking unit 1113.

The sub-undertaker may judge whether it has the ability to undertake the target project according to the released sub-demand definition document. Alternatively, the sub-undertaker may also communicate the target project with the project advisor according to the demand definition document, so as to more accurately judge whether it has the ability to undertake the target project. For example, in the case where the sub-undertaker confirms that it has the ability to undertake the target project, the sub-undertaker may execute a second confirmation operation in the cloud service sub-system 110, so that the cloud service sub-system 110 generates the second confirmation information according to the second confirmation operation. In response to receiving the second confirmation information, the sub-project undertaking unit 1114 grants product development permission of the sub-project to the sub-undertaker.

In some embodiments of the present disclosure, the undertaker may sign a contract with the demander on the research and development platform 100, and the sub-undertaker undertaking the sub-project may sign a contract with the project undertaker on the product research and development platform, so as to quickly build a temporary team of the target project.

In some embodiments of the present disclosure, the cloud service sub-system 110 is further configured to determine, according to the project demand and by using a neural network technology, at least one project undertaker matching the project demand from a project undertaker library, and push the target project to the at least one project undertaker.

In some embodiments of the present disclosure, the project undertaker library may be a database maintained by the cloud service sub-system 110, or may also be a database independent of the cloud service sub-system 110. The cloud service sub-system 110 may acquire the project undertaker from the project undertaker library.

As illustrated in FIG. 2, the cloud service sub-system 110 may further include an intelligent precise matching module 113. The intelligent precise matching module 113 may include a matching model, so as to determine, according to the project demand and by using the matching model, at least one project undertaker matching the project demand from the undertaker library.

For example, the matching model is acquired by training with a large amount of historical project data. For example, the historical project data includes the project demand of the historical project and the project undertaker who undertook the historical project. The project demand of the historical project is used as input of a neural network model, and the project undertaker of the historical project is used as output of the neural network model, so as to acquire the matching model by training the neural network model. The neural network model, for example, may be a convolutional neural network, a recurrent neural network, a deep neural network, and so on. This method adopts an artificial intelligence technology to intelligently match the information of the demander and the project undertaker, which reduces the difficulty in docking between the demander and the project undertaker.

In some embodiments of the present disclosure, the research and development system 110 constructs a user credit system and a transaction security system by using a blockchain technology. Using the blockchain technology to construct the user credit system and the transaction security system on the research and development system, can prevent transaction tampering, reduces security risks, and reduces users' concerns about the Internet platform.

In some embodiments of the present disclosure, the intelligent precise matching module 113, the user credit system, and the transaction security system, etc. may be hardware, software, firmware, and any feasible combination thereof. For example, the intelligent precise matching module 113, the user credit system, and the transaction security system, etc. may be dedicated or general-purpose circuits, chips, or apparatuses, etc., or may also be a combination of a processor and a memory. Specific implementation forms of the above-described respective modules are not limited in the embodiments of the present disclosure.

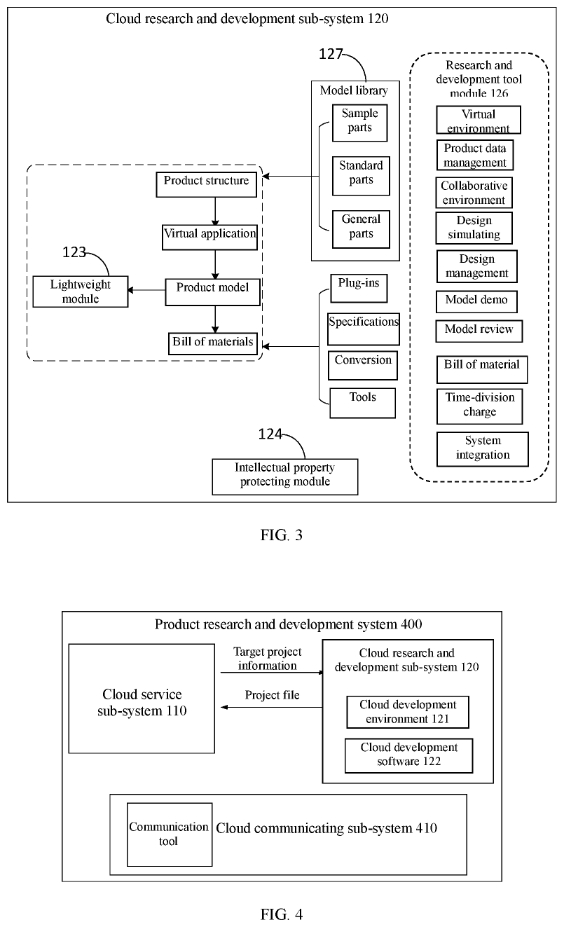

FIG. 3 illustrates a schematic block diagram of the cloud research and development sub-system 120 provided by at least one embodiment of the present disclosure.

As illustrated in FIG. 3, the cloud research and development sub-system 120 may include a research and development tool module 126. The research and development tool module 126 may provide various tools for research and development of the target project. For example, the research and development tool module 126 provides the cloud research and development environment and the cloud development software as described above, so as to use the cloud development environment and the cloud development software to develop the target project.

For example, the research and development tool module 126 may include, for example, a virtual environment module. The virtual environment module provides the cloud research and development environment.

For example, the research and development tool module 126 may further include, for example, a product data management module, a collaborative environment module, a design simulating module, a design management module, a model demo module, a model review module, a material bill module, and the like.

In some embodiments of the present disclosure, the cloud research and development sub-system may include a model library 127. The model library 127 provides a plurality of manufacturer sample parts libraries, a plurality of standard parts libraries, and a plurality of general parts libraries.

The cloud research and development sub-system 120 is further configured to receive a selection operation executed in the cloud development environment and the cloud development software, and determine, according to the selection operation, a selection model from the model library 127. The selection model is used for research and development of the target project. Designers or product developers may directly select the sample parts library, the standard parts library, or the general parts library from the model library, which greatly improves the modeling speed for the designers to use the cloud development software for product development and design.

In some embodiments of the present disclosure, the cloud research and development sub-system is further configured to generate a bill of materials of basic products used in research and development of the target project.

The cloud research and development sub-system 120 is responsible for functions such as model design and simulation of the products researched and developed, and is a research and development implementation part of the research and development system. For example, research and development personnel build a product structure based on the project-related information of the target project transmitted by the cloud service sub-system 110, and then use relevant professional design software in a virtual application (i.e., the cloud development software) to design the product, and the bill of materials of the product is generated simultaneously in the design process, so as to facilitate purchasing and fabrication.

In the design process, various plug-ins, design specifications, conversion tools, etc. provided by the system may also be used.

In some embodiments of the present disclosure, the cloud research and development sub-system 120 may include a lightweight module 123, and the lightweight module 123 is configured to perform lightweight processing on a model including a plurality of details during the research and development process, so as to demonstrate to a remote authorized user through a network.

For example, the lightweight module includes a lightweight model. Embedding the lightweight model in the cloud research and development sub-system 120 can improve real-time performance of network communication and facilitate the user to view the design model through a browser.

The cloud research and development sub-system 120 may further include an intellectual property protecting module 124. The intellectual property protecting module 124 is configured to record technical information generated during the research and development process of the target project, and output a query result in response to receiving a query instruction for querying the technical information.

For example, the intellectual property protecting module 124 may use a data traceability technology to make a key mark on process history and documents of user communication, and provide a search function, which effectively traces and protects designers' intellectual property right, and reduces users' concerns about communication on the Internet platform.

In some embodiments of the present disclosure, the research and development tool module in the cloud research and development sub-system 120 may be hardware, software, firmware, and any feasible combination thereof. For example, the product data management module, the collaborative environment module, the design simulating module, the design management module, the model demo module, the model review module, the material bill module, the lightweight module 123, the intellectual property protecting module 124, etc. may be dedicated or general-purpose circuits, chips, or apparatuses, etc., or may also be a combination of a processor and a memory. Specific implementation forms of the above-described respective modules are not limited in the embodiments of the present disclosure.

FIG. 4 illustrates a schematic diagram of another research and development system 400 provided by at least one embodiment of the present disclosure.

As illustrated in FIG. 4, the research and development system 400 may further include a cloud communicating sub-system 410 on the basis of the foregoing embodiments.

The cloud communicating sub-system 410 is deployed with a communication tool, and is configured to provide usage permission of the communication tool, so that a plurality of target objects associated with the target project are capable of communicating through the communication tool.

The cloud communicating sub-system 410 implements links such as product development and technical communication in the product research and development process, which, thus, avoids the case where communication can be carried out only offline or by using a third-party application, truly implements full-element open collaborative research and development, facilitates joint research and development for a plurality of participants, and improves efficiency of product research and development.

In the embodiment illustrated in FIG. 4, the research and development system includes the cloud service sub-system, the cloud research and development sub-system, and the cloud communicating sub-system. The three sub-systems work collaboratively, so as to ensure cloud manner of the entire product research and development process of the user, and truly implement cloud collaborative design.

The cloud communicating sub-system is further configured to interact with the cloud service sub-system and the cloud research and development sub-system, so as to acquire shared information in the project information from the cloud service sub-system, and/or acquire research and development information from the cloud research and development sub-system.

In some embodiments of the present disclosure, the cloud communicating sub-system 410 takes project communication as a main line, and uses Internet communication tools to perform communication in various ways, so as to help users summarize communication conclusions. The communication tools may include, for example, functions such as instant communication, audio communication, video conferencing, document sharing, desktop sharing, document collaboration, and the like. All the Internet communication tools may be used independently or crosswise, and finally summarized conclusions may be shared in authorized user spaces.

In some embodiments of the present disclosure, the cloud communicating sub-system 410 may be hardware, software, firmware, and any feasible combination thereof. The cloud communicating sub-system 410 may be a dedicated or general-purpose circuit, a chip, or an apparatus, etc., or may also be a combination of a processor and a memory. Specific implementation forms of the above-described respective sub-systems are not limited in the embodiments of the present disclosure.

In some embodiments of the present disclosure, the research and development system may be a single sign-on system, that is, the user only needs to register or log in to any sub-system in the research and development system, and then the user may use all modules of respective sub-systems in the research and development system according to permission assignment. The three sub-systems may also be used independently to meet demands of different user application scenarios.

It should be noted that in the embodiments of the present disclosure, the term “cloud” in the cloud service sub-system, cloud research and development sub-system, cloud communicating sub-system, cloud development environment, cloud development software, etc. refers to the abstract description of usage of the network or the Internet to provide corresponding functions. The calculation that implements the corresponding functions is not deployed on the local computer, but is deployed on the network. For example, a large number of distributed computers can be used to form a computer network, and the computer network works together as a whole to provide the corresponding functions of the cloud service sub-system, cloud research and development sub-system, cloud communicating sub-system, cloud development environment, and cloud development software.

It should be noted that in the embodiments of the present disclosure, the research and development system can be implemented through a computer network, and the computer network may include one or more computers or servers, and respective computers or servers are connected to each other through a network or the Internet.

At least one embodiment of the present disclosure provides a research and development method, which is applied to a research and development system. The research and development system includes a cloud service sub-system and a cloud research and development sub-system, and the cloud research and development sub-system is deployed with a cloud development environment and cloud development software.

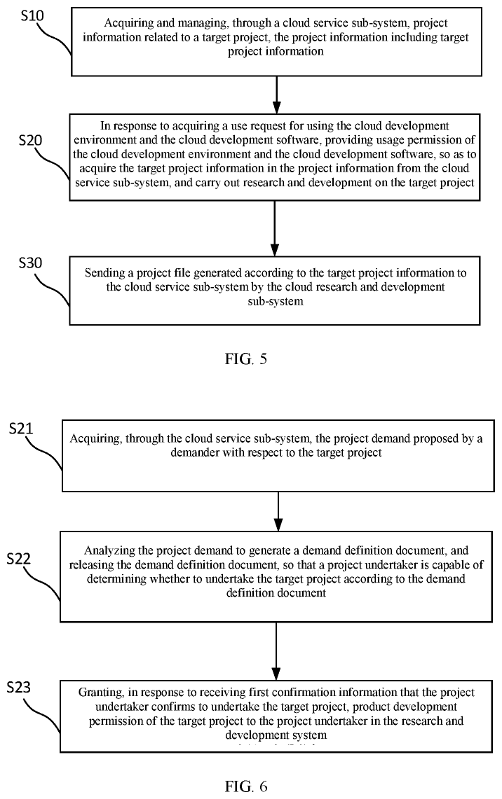

FIG. 5 illustrates a flow chart of a research and development method provided by at least one embodiment of the present disclosure.

As illustrated in FIG. 5, the method may include step S10 to step S30.

Step S10: acquiring and managing, through the cloud service sub-system, project information related to a target project. The project information includes target project information.

For example, the cloud service sub-system may be the cloud service sub-system 110 as described above in FIG. 1.

Step S20: in response to acquiring a use request for using the cloud development environment and the cloud development software, providing usage permission of the cloud development environment and the cloud development software, so as to acquire the target project information in the project information from the cloud service sub-system and carry out research and development on the target project.

For example, the user may log in to the cloud research and development sub-system 120 as described above in FIG. 1, and request to run the cloud development environment and the cloud development software in the cloud research and development sub-system 120, to use the cloud development environment and the cloud development software, so as to carry out research and development on the target project.

Step S30: sending a project file generated according to the target project information to the cloud service sub-system by the cloud research and development sub-system.

For example, in the process of using the cloud research and development sub-system to complete the target project, the cloud research and development sub-system may send the project file of the target project to the cloud service sub-system.

The research and development method implements online collaboration from proposal of the project demand to research and development of the target project, so that the target project information may be directly acquired from the cloud service sub-system, and the cloud development environment and the cloud development software provided are used for development without additionally searching, installing and downloading any cloud development environment and cloud development software, thereby improving research and development efficiency and implementing full-element open online collaborative research and development, and facilitating joint research and development of a plurality of participants.

FIG. 6 illustrated a flow chart of step S20 in FIG. 5 provided by at least one embodiment of the present disclosure.

As illustrated in FIG. 6, the method may include step S21 to step S23.

Step S21: acquiring, through the cloud service sub-system, the project demand proposed by a demander with respect to the target project.

For example, the demander may log in to the cloud service sub-system and input the project demand of the target project in the cloud service sub-system.

Step S22: analyzing the project demand to generate a demand definition document, and releasing the demand definition document, so that a project undertaker is capable of determining whether to undertake the target project according to the demand definition document.

For example, the step S22 may be executed by the demand clarifying unit 1112 as described above, and no detail is repeated here.

Step S23: granting, in response to receiving first confirmation information that the project undertaker confirms to undertake the target project, product development permission of the target project to the project undertaker in the research and development system.

For example, in the case where the project undertaker confirms that it has the ability to undertake the target project, then the project undertaker may execute a first confirmation operation in the cloud service sub-system 110, so that the cloud service sub-system 110 generates the first confirmation information according to the first confirmation operation. For example, the step S23 may be executed by the project undertaking unit 1113 as described above in FIG. 2, and no detail is repeated here.

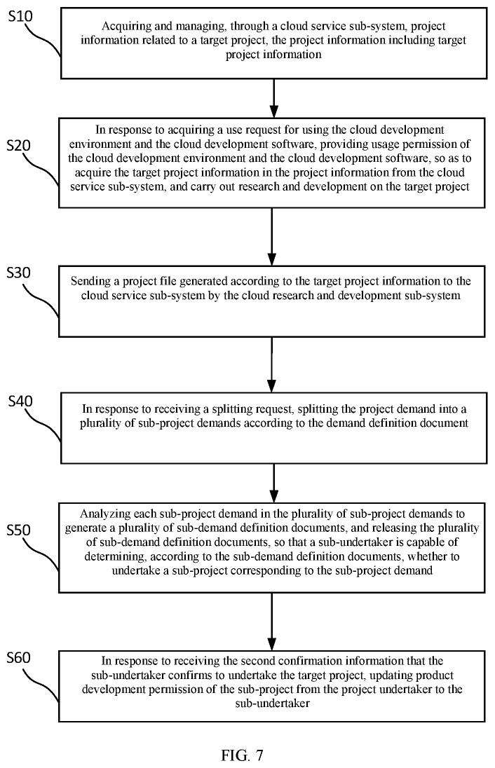

FIG. 7 illustrates a flow chart of another research and development method provided by at least one embodiment of the present disclosure.

As illustrated in FIG. 7, the method may further include step S40 to step S60 on the basis of the foregoing embodiments.

Step S40: in response to receiving a splitting request, splitting the project demand into a plurality of sub-project demands according to the demand definition document.

For example, the splitting request may be generated in the case where the demander or the project advisor or the project undertaker selects a “Split” icon on a front-end interface.

For example, in the step S40, the technology splitting tool 112 as described above in FIG. 2 may be used to split the project, and no detail is repeated here.

Step S50: analyzing each sub-project demand in the plurality of sub-project demands to generate a plurality of sub-demand definition documents, and releasing the plurality of sub-demand definition documents, so that a sub-undertaker is capable of determining, according to the sub-demand definition documents, whether to undertake a sub-project corresponding to the sub-project demand.

For example, the step S50 may be executed by the demand clarifying unit as described above in FIG. 2, and no detail is repeated here.

Step S60: in response to receiving the second confirmation information that the sub-undertaker confirms to undertake the target project, updating the product development permission of the sub-project from the project undertaker to the sub-undertaker.

In the embodiments of the present disclosure, for example, the step 60 may be executed by the sub-project undertaking unit 1114 as described above in FIG. 2, and no detail is repeated here.

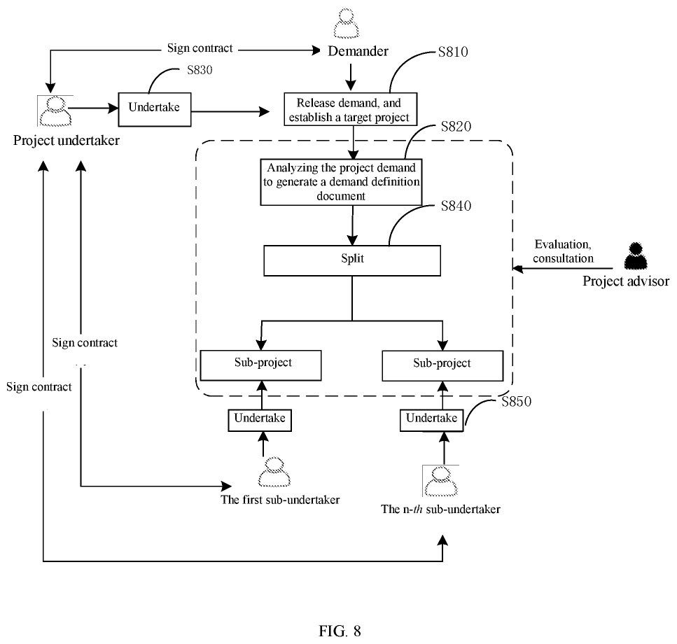

FIG. 8 illustrates a flow chart of another research and development method provided by at least one embodiment of the present disclosure.

As illustrated in FIG. 8, the research and development method may include step S810 to step S850.

Step S810: releasing, by a demander, a project demand on the cloud service sub-system, and establishing a target project.

For example, the demander may log in to the cloud service sub-system, input and release the project demand in the cloud service sub-system, and establish the name of the target project of the project demand.

Step S820: analyzing the project demand to generate a demand definition document, and releasing the demand definition document, so that a project undertaker is capable of determining whether to undertake the target project according to the demand definition document.

The step S22 may be executed by the demand clarifying unit 1112 as described above, and no detail is repeated here.

Step S830: in response to receiving first confirmation information that the project undertaker confirms to undertake the target project, granting product development permission of the target project to the project undertaker in the research and development system.

With respect to the step S830, the project undertaker undertakes the target project, and the project undertaker and the demander may sign a contract with respect to the target project in the research and development system.

Step S840: in response to receiving a splitting request, splitting the project demand into a plurality of sub-project demands according to the demand definition document. The plurality of sub-project demands respectively correspond to a plurality of sub-projects.

Each sub-project demand is analyzed to generate a plurality of sub-demand definition documents. The plurality of sub-demand definition documents are released, so that the sub-undertaker is capable of determining whether to undertake a sub-project corresponding to the sub-project demand through the sub-demand definition document.

Step S850: in response to receiving second confirmation information that the sub-undertaker confirms to undertake the target project, updating product development permission of the sub-project from the undertaker to the sub-undertaker.

There may be a plurality of sub-undertakers, for example, the sub-undertakers may include a first sub-undertaker to an n-th sub-undertaker.

With respect to the step S850, in the case where the sub-undertaker confirms to undertake the sub-project, the sub-undertaker and the project undertaker may sign a contract with respect to the sub-project in the research and development system.

In some other embodiments of the present disclosure, the research and development system further includes a cloud communicating sub-system. The cloud communicating sub-system is deployed with a communication tool. Target objects associated with the target project include a first target object and a second target object. The method further includes: receiving a project message sent by the first target object through the communication tool. The target receiving object of the project message is the second target object, and the project message is sent to the second target object through the communication tool.

For example, the target object associated with the target project may be the demander who releases the project demand of the target project, the undertaker who undertakes the target project, or the sub-undertaker who undertakes the sub-project.

In some embodiments of the present disclosure, the project message includes at least one of a group consisting of audio and video messages, video conferences, document sharing messages, and desktop sharing messages.

For example, the first target object may send a document sharing message to the second target object through the communication tool, and the communication tool may send the document sharing message to the second target object, so that the document may be shared to a terminal device of the second target object.

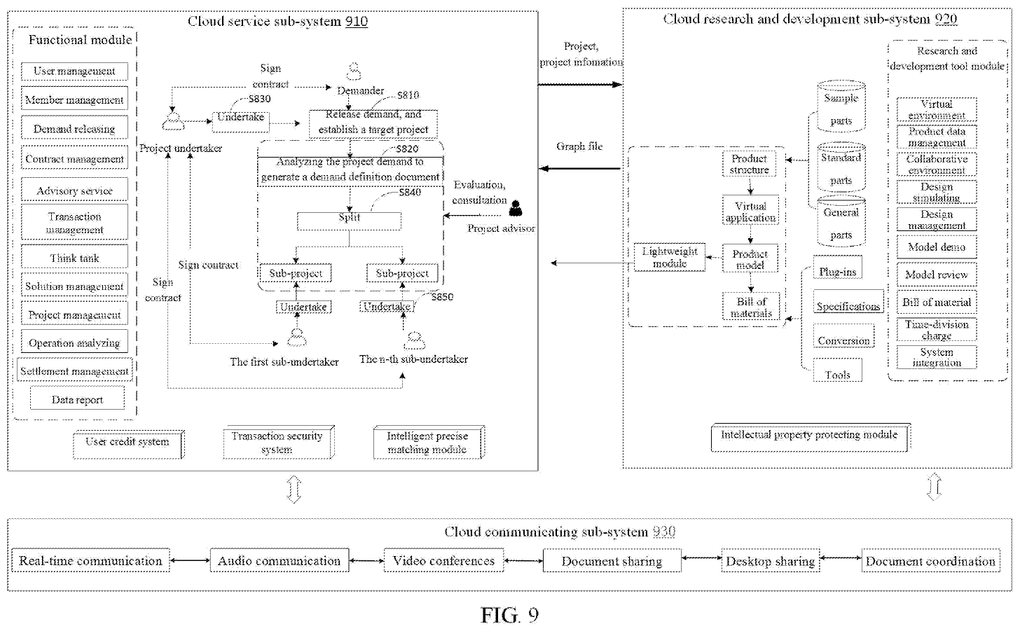

FIG. 9 illustrates a structural schematic diagram of another research and development system provided by at least one embodiment of the present disclosure.

As illustrated in FIG. 9, the research and development system may include a cloud service sub-system 910, a cloud research and development sub-system 920, and a cloud communicating sub-system 930.

Structures and functions of the cloud service sub-system 910 are similar to those of the cloud service sub-system 110 as described above with reference to FIG. 2, and no detail is repeated here.

As illustrated in FIG. 9, the cloud service sub-system 910 may execute step S810 to step S850 as described above with reference to FIG. 8.

Structures and functions of the cloud research and development sub-system 920 are similar to those of the cloud research and development sub-system 120 as described above with reference to FIG. 3, and no detail is repeated here.

Structures and functions of the cloud communicating sub-system 930 are similar to those of the cloud communicating sub-system 410 as described above with reference to FIG. 4, and no detail is repeated here.

As illustrated in FIG. 9, the cloud service sub-system 910 may send the project or the basic project information to the cloud research and development sub-system 920. The cloud research and development sub-system 920 may send a graph file to the cloud service sub-system 910. The graph file is a project file.

The research and development system illustrated in FIG. 9 may improve efficiency of product research and development, implement full-element collaborative research and development, and facilitate joint research and development of a plurality of participants. In some embodiments of the present disclosure, the above-described research and development system may include a server cluster or a separate server, and the functions provided by the cloud service sub-system, the cloud research and development sub-system, and the cloud communicating sub-system as described above are implemented through the server cluster or the separate server.

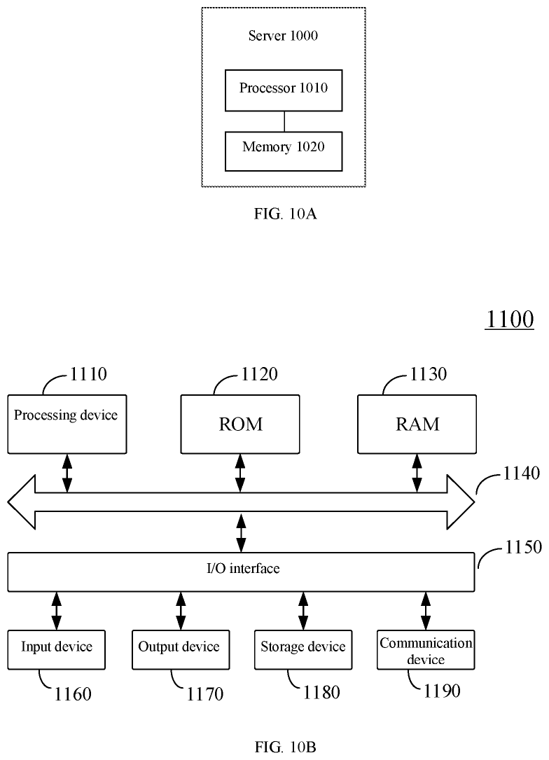

FIG. 10A illustrates a schematic block diagram of a server provided by some embodiments of the present disclosure.

As illustrated in FIG. 10A, a server 1000 includes a processor 1010 and a memory 1020. The memory 1020 is configured to store non-transitory computer-readable instructions (e.g., one or more computer program modules). The processor 1010 is configured to run the non-transitory computer-readable instructions, and when executed by the processor 1010, the non-transitory computer-readable instructions may execute one or more steps in the research and development method as described above. The memory 1020 and the processor 1010 may be interconnected through a bus system and/or other form of connection mechanism (not shown).

It should be noted that, in the embodiments of the present disclosure, for specific functions and technical effects of the server 1000, description of the research and development method and the research and development system as described above may be referred to, and no detail is repeated here. For example, the server 1000 may serve as any one or more of the cloud service sub-system, the cloud research and development sub-system, and the cloud communicating sub-system, so as to implement the functions and services provided by the corresponding sub-system.

FIG. 10B illustrates a schematic block diagram of an electronic device provided by some embodiments of the present disclosure. The electronic device 1100 is, for example, suitable for being used as the research and development system provided by the embodiments of the present disclosure, so as to implement the research and development method provided by the above-described embodiments of the present disclosure. The electronic device 1100 may be a server or the like. It should be noted that, the electronic device 1100 illustrated in FIG. 10B is only an example, which does not bring any limitation to the function and use scope of the embodiments of the present disclosure.

As illustrated in FIG. 10B, the electronic device 1100 may include a processing device (e.g., a central processing unit, a graphics processor, etc.) 1110, which may executes various appropriate actions and processing according to a program stored in a read-only memory (ROM) 1120 or a program loaded into a random access memory (RAM) 1130. The random access memory (RAM) 1130 further stores various programs and data required for operation of the electronic device 1100. The processing device 1110, the ROM 1120, and the RAM 1130 are connected with each other through a bus 1140. An input/output (I/O) interface 1150 is also coupled to the bus 1140.

Usually, devices below may be coupled to the I/O interface 1150: an input device 1160 including, for example, a touch screen, a touch pad, a keyboard, a mouse, a camera, a microphone, an accelerometer, a gyroscope, etc.; an output device 1170 including, for example, a liquid crystal display (LCD), a speaker, a vibrator, etc.; a storage device 1180 including, for example, a magnetic tape, a hard disk, etc.; and a communication device 1190. The communication device 1190 may allow the electronic device 1100 to perform wireless or wired communication with other electronic device so as to exchange data. Although FIG. 10B illustrates the electronic device 1100 having various devices, it should be understood that, it is not required to implement or have all the devices illustrated, and the electronic device 1100 may alternatively implement or have more or fewer devices.

For example, according to the embodiments of the present disclosure, the above-described research and development method may be implemented as a computer software program. For example, the embodiments of the present disclosure include a computer program product, which includes a computer program carried on a non-transitory computer-readable medium, and the computer program includes program codes for executing the above-described research and development method. In such embodiments, the computer program may be downloaded and installed from a network through the communication device 1190, or be installed from the storage device 1180, or installed from the ROM 1120. When executed by the processing device 1110, the computer program may implement the functions defined in the research and development method provided by the embodiments of the present disclosure.

What have been described above are only some embodiments of the present disclosure, and are not tend to limit the present disclosure. Any modification, equivalent substitution, improvement, etc. made within the spirit and principles of the present disclosure shall be included in the scope of protection of the present disclosure.

What have been described above are only specific implementations of the present disclosure, the protection scope of the present disclosure is not limited thereto, and the protection scope of the present disclosure should be based on the protection scope of the claims.

1. A research and development system, comprising a cloud service server computer and a cloud research and development server computer in communicative connection with each other, wherein each server computer comprises a processor and a memory,
wherein the cloud service server computer is configured to manage project information related to a target project; and
the cloud research and development server computer is deployed with a cloud development environment and cloud development software, and is configured to acquire target project information in the project information from the cloud service server computer, provide usage permission of the cloud development environment and corresponding cloud development software, and transmit, to the cloud service server computer, a project file generated according to the target project information to perform research and development on the target project;
the cloud service server computer comprises a demand releasing unit, a demand clarifying unit, and a project undertaking unit, and the target project information comprises a project demand;
the demand releasing unit is configured to acquire a project demand proposed by a demander with respect to the target project, and release the project demand;
the demand clarifying unit is configured to analyze the project demand to generate a demand definition document, and release the demand definition document to allow a project undertaker to be capable of determining whether to undertake the target project according to the demand definition document; and
the project undertaking unit is configured to grant, in response to receiving first confirmation information that the project undertaker confirms to undertake the target project, product development permission of the target project to the project undertaker in the research and development system;
the cloud service server computer further comprises:
a technology splitting tool, configured to split the project demand into a plurality of sub-project demands; and
the demand clarifying unit is further configured to analyze each sub-project demand in the plurality of sub-project demands to generate a plurality of sub-demand definition documents, and release the plurality of sub-demand definition documents to allow a sub-undertaker to be capable of determining, according to the plurality of sub-demand definition documents, whether to undertake a sub-project corresponding to the sub-project demand;
the cloud research and development server computer comprises a model library,
the cloud research and development server computer is further configured to receive a selection operation executed in the cloud development environment and the cloud development software, and determine, according to the selection operation, a selection model from the model library, and the selection model is used for research and development of the target project; and
the model library provides a plurality of manufacturer sample parts libraries, a plurality of standard parts libraries, and a plurality of general parts libraries.

2. The research and development system according to claim 1, further comprising:
a cloud communicating server computer, deployed with a communication tool, and configured to provide usage permission of the communication tool, and allow a plurality of target objects associated with the target project to be capable of communicating through the communication tool.

3. The research and development system according to claim 2, wherein the cloud communicating server computer is further configured to interact with the cloud service server computer and the cloud research and development server computer, and acquire shared information in the project information from the cloud service server computer, and/or acquire research and development information from the cloud research and development server computer.

4. (canceled)

5. (canceled)

6. The research and development system according to claim 1, wherein the cloud service server computer further comprises a sub-project undertaking unit, and the sub-project undertaking unit is configured to grant, in response to receiving second confirmation information that the sub-undertaker confirms to undertake the sub-project, product development permission of the sub-project to the sub-undertaker.

7. The research and development system according to claim 1, wherein the cloud service server computer is further configured to determine, according to a project demand of the target project and by using a neural network technology, at least one project undertaker matching the project demand from a project undertaker library, and push the target project to the at least one project undertaker.

8. The research and development system according to claim 1, wherein managing the project information related to the target project comprises:
releasing a project demand of the target project, splitting the project demand into a plurality of sub-project demands, managing undertaking information of the target project, and managing process of the target project.

9. The research and development system according to claim 1, wherein the cloud service server computer further comprises a contract management module, an advisory service module, and a transaction management module,
the contract management module is configured to generate a contract for the target project and manage the contract,
the advisory service module is configured to receive consultation information from a demander, determine reply information of the consultation information, and feed the reply information back to the demander, and
the transaction management module is configured to manage transaction information of the target project.

10. The research and development system according to claim 1, wherein the research and development system is capable of constructing a user credit system and a transaction security system by using a blockchain technology.

11. (canceled)

12. The research and development system according to claim 1, wherein the cloud research and development server computer is further configured to generate a bill of materials of basic products used in research and development of the target project.

13. The research and development system according to claim 1, wherein the cloud research and development server computer comprises a lightweight module, and the lightweight module is configured to perform lightweight processing on a model comprising a plurality of details during a research and development process.

14. The research and development system according to claim 1, wherein the cloud research and development server computer comprises an intellectual property protecting module, and the intellectual property protecting module is configured to record technical information generated during a research and development process of the target project, and output a query result in response to receiving a query instruction for querying the technical information.

15. The research and development system according to claim 1, wherein the research and development system is a single sign-on system.

16. A research and development method, applied to a research and development system, wherein the research and development system comprises a cloud service server computer and a cloud research and development server computer, each server computer comprises a processor and a memory, the cloud research and development server computer is deployed with a cloud development environment and cloud development software, and the method comprises:
acquiring and managing, through the cloud service server computer, project information related to a target project, wherein the project information comprises target project information;
in response to acquiring a use request for using the cloud development environment and the cloud development software, providing usage permission of the cloud development environment and the cloud development software, acquiring the target project information in the project information from the cloud service server computer, and carrying out research and development on the target project; and
sending a project file generated according to the target project information to the cloud service server computer by the cloud research and development server computer,
wherein the target project information comprises a project demand, and acquiring the project information related to the target project through the cloud service server computer comprises:
acquiring, through the cloud service server computer, the project demand proposed by a demander with respect to the target project;
analyzing the project demand to generate a demand definition document, and releasing the demand definition document to allow a project undertaker to be capable of determining whether to undertake the target project according to the demand definition document; and
granting, in response to receiving first confirmation information that the project undertaker confirms to undertake the target project, product development permission of the target project to the project undertaker in the research and development system; the method further comprises:
in response to receiving a splitting request, splitting the project demand into a plurality of sub-project demands according to the demand definition document;
analyzing each sub-project demand in the plurality of sub-project demands to generate a plurality of sub-demand definition documents, and releasing the plurality of sub-demand definition documents to allow a sub-undertaker to be capable of determining, according to the sub-demand definition documents, whether to undertake a sub-project corresponding to the sub-project demand; and
in response to receiving second confirmation information that the sub-undertaker confirms to undertake the target project, updating the product development permission of the sub-project from the undertaker to the sub-undertaker,
wherein the cloud research and development server computer comprises a model library,
the cloud research and development server computer is further configured to receive a selection operation executed in the cloud development environment and the cloud development software, and determine, according to the selection operation, a selection model from the model library, and the selection model is used for research and development of the target project; and
the model library provides a plurality of manufacturer sample parts libraries, a plurality of standard parts libraries, and a plurality of general parts libraries.

17. (canceled)

18. (canceled)

19. The method according to claim 16, wherein the research and development system further comprises a cloud communicating, server computer the cloud communicating server computer is deployed with a communication tool, target objects associated with the target project comprise a first target object and a second target object, and the method further comprises:
receiving a project message sent by the first target object through the communication tool, wherein a target receiving object of the project message is the second target object; and
sending the project message to the second target object through the communication tool.

20. The method according to claim 19, wherein the project message comprises at least one of a group consisting of audio and video messages, video conferences, document sharing messages, or desktop sharing messages.
